(19) United States
(12) Patent Application Publication
(10) Pub. No.: US 2007/0145775 A1
(43) Pub. Date: Jun. 28, 2007

(54) SAFETY SCREEN FOR VEHICLE

(76) Inventor: Edward Smith, Revere, MA (US)

Correspondence Address: LAW OFFICE OF BRETT N. DORNY, 386 WEST MAIN STREET, SUITE 12A, NORTHBOROUGH, MA, 01532, US

(21) Appl. No.: 11/616,292

(22) Filed: Dec. 27, 2006

Related U.S. Application Data
(60) Provisional application No. 60/754,057, filed on Dec. 27, 2005.
(60) Provisional application No. 60/754,758, filed on Dec. 28, 2005.

(51) Int. Cl. B60J 1/10

(52) U.S. Cl. 296/146.15

(57) ABSTRACT

A safety screen for a vehicle is formed of a frame and a rigid mesh. The screen can be installed on the vehicle in various manners. The screen allows ventilation and visibility while providing security for occupants and from intruders.

### CROSS REFERENCES TO RELATED APPLICATIONS

Priority is claimed to U.S. Provisional Patent Application Nos. 60/754,057 and 60/754,758, filed Dec. 27, 2005 and Dec. 29, 2005, respectively.

### BACKGROUND OF THE INVENTION

1. Field of the Invention

The present invention relates to safety devices for motor vehicles. More particularly, it relates to safety screens which allow airflow while preventing unauthorized access.

2. Discussion of Related Art

Motor vehicles typically include multiple windows so that the driver can see around the vehicle for operation. Many of the windows are design to open in various manners so that fresh air can enter the vehicle. However, when a window is open, insects and other undesirable objects may enter the vehicle. Similarly, passengers, particularly children and pets, may extend their head, arms, and legs through an open window. They can be easily injured by objects moving past the vehicle. Also, a passenger may accidentally fall out on open window. This can be a particular problem on school buses where many children ride with minimal adult supervision. Typically, ventilation through open windows is necessary in a school bus to maintain a desirable temperature. The open windows may present a hazard to the children. Therefore, a need exists for a safety system which allows a vehicle window to be opened while protecting the occupants of the vehicle.

When a vehicle is parked, the interior becomes oppressively hot very quickly. Far too often, one reads about a child or pet left in a car that is badly harmed or killed by the heat in the vehicle. Windows which are left open to allow for ventilation to control the temperature of the parked vehicle are a security risk. The children or pets may fall out of an open window. Unauthorized persons may be able to access the vehicle or its contents through an open window. When windows are closed sufficiently to prevent undesired accesses, the remaining opening is insufficient to provide ventilation. Therefore, a need exists for a safety screen which allows a vehicle to be securely left with sufficient ventilation to maintain an acceptable interior temperature.

A variety of screen systems have been proposed for vehicles over the many years that vehicles have been made. Some such screens are designed to keep out insects. They are generally formed of a fabric or plastic mesh. Such screens do not function well for security purposes. They can be easily torn so that persons may enter or fall from the vehicle. Other screens are manually inserted into the window opening. Such screens must be carried separately. They can easily become separated from the vehicle so that they are not available when needed. Some such screens are attached to the interior or exterior of the vehicle so that they can be moved into place when needed. While this prevents the screen from becoming lost, it takes up needed space in the vehicle or hinders airflow around the vehicle. Some screens have been proposed to be located in the doors of the vehicle along with the window glass. The screen could be opened and closed in the same manner as the glass. However, such screens, as with the first type discussed above, are of a fabric or plastic mesh and do not provide security from intruders. Also, such screens cannot be used on vehicles with casement or sliding windows, such as the rear of SUVs and minivans, and busses, including school busses. Therefore, a need exists for security screens which provide protection for different kinds of windows.

### SUMMARY OF THE INVENTION

The present invention substantially overcomes various deficiencies in the prior art by providing a safety screen for use in vehicles. The invention includes several variations depending upon the nature of the window.

According to one aspect of the invention, the screen is formed of a wire mesh. As is known in the art, the wire mesh may be formed in a variety of manners. The mesh may be formed through weaving of individual wires. Alternatively, it may be formed by shaping holes in a metal sheet. The wire mesh is held within a frame. The frame is shaped in a manner similar to the window to be covered. It may be the same size as the window, if within the window tracks, or slightly larger if held on a separate track in front of the window.

According to one aspect of the invention, the safety screen includes a pair of tracks in a door of the vehicle. The tracks are positioned next to and parallel to the tracks for the window. According to another aspect of the invention, the screen can be includes a regulator or other mechanism for raising and lowering the screen within the tracks. According to another aspect of the invention, the safety screen includes a motor for raising and lowering the screen. The motor is operated with a switch positioned on the interior of the door. The switch may be similar to that used to raise and lower the window glass. According to another aspect of the invention, the window switch also operates to control the screen.

According to another aspect of the invention, the safety screen includes a pair of tracks positioned on the outside of the vehicle adjacent to the window. The safety screen slides within the pair of tracks next to the vehicle.

According to another aspect of the invention, the screen fits within a standard track for the vehicle. The screen includes at least two resilient extensions from the frame. The screen is sized to fit within the window track when the resilient extensions are compressed.

### BRIEF DESCRIPTION OF THE DRAWINGS

FIG. 1 is a drawing of a basic screen according to an embodiment of the present invention.

FIGS. 2A and 2B are details metal screens according to embodiments of the present invention.

FIG. 3 is a partial cutaway drawing of a vehicle door having a motorized screen according to an embodiment of the present invention.

FIG. 4 is a partial cut away view of a vehicle door having a motorized screen according to another embodiment of the present invention.

FIG. 5 is a cross sectional view of the door of FIG. 4.

FIG. 6 is a front view of a screen for a framed window.

FIG. 7 is a front view of a screen for the rear window of an SUV.

FIG. 8 is a front view of a screen within a sliding truck window.

FIG. 9 is a front view of the screen of FIG. 8.

FIG. 10 is a cross-sectional view of a mounted screen according to an embodiment of the present invention.

FIG. 11 is a cross-sectional view of a mounted screen according to another embodiment of the present invention.

### DETAILED DESCRIPTION

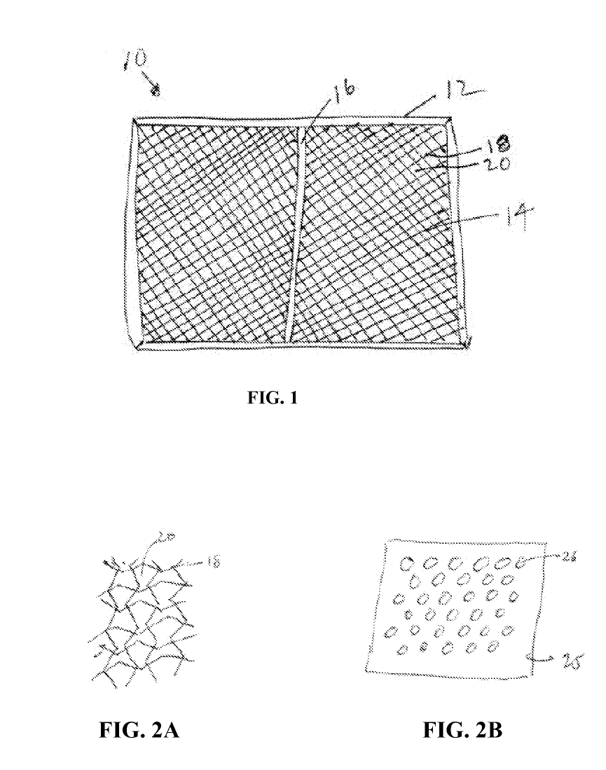

The present invention provides a safety screen for windows in vehicles. The screen covers an opening of the window to prevent ingress by unauthorized persons and to prevent the accident egress by occupants. A basic safety screen 10 according to an embodiment of the invention is illustrated in FIG. 1. The screen 10 has a frame 12 and a mesh 14. The frame 12 surrounds the periphery of the mesh 14 to provide stability to the screen 10. Preferably, the frame 12 is formed of a metal which is folded and welded to provide a stiff support around the mesh 14. The frame 12 maintains the shape of the screen 10 whether or not the screen is installed on the vehicle. The frame 12 may include cross braces (not shown) at various locations and directions to add greater stability to the screen 10. The frame 12 also prevents any sharp edges of the mesh 14 from being exposed so prevent injury. The frame may include hinges (not shown) or other devices for connecting parts of the frame. The hinges allow the screen 10 to be folded to a more compact size for storage or transport.

The mesh 14 allows for ventilation and visibility. The mesh 14 may be formed in various manners. According to an embodiment of the invention, the mesh is formed of a metal or other material which provides sufficient strength to the screen to prevent accidental or intentional passage through the mesh 14. FIGS. 2A and 2B illustrate possible constructions of the mesh 14. As illustrated in FIG. 2A, the mesh 14 may include a network of interlinked strands 18 the form a web-like structure with a multiplicity of small openings 20. The area of the openings 20 is a significant amount of the area of the screen 10 to provide a reasonable amount of visibility and air flow through the screen. The large number of openings further provides air flow for ventilation. The strands may be interlinked in any known manner. As is known in the art, the strands may be woven or may be welded together to form the mesh. Preferably, when the mesh 14 is formed, the material is strong enough to make the mesh rigid or nearly rigid. Such materials include metals (such as steel, chrome and/or aluminum), carbon composites, and fiberglass. Of course, other materials could be used which will provide the necessary rigidity. The rigid material provides safety in that it is extremely difficult to rupture from either the inside or outside. A child or pet can push against the screen without destroying the mesh 14. Similarly, an intruder cannot easily access the vehicle through the mesh 14.

FIG. 2B illustrates another embodiment of the mesh 14. In this embodiment, the mesh 14 is formed of a sheet 25 of material with a plurality of voids 26 formed or cut into the material. As in the first embodiment, the voids are formed be a substantial portion of the material to allow air to flow and visibility from the interior of the vehicle. Again, the material is of sufficient strength to provide rigidity to the screen. In forming the screen, the material may remain planar, as illustrated in FIG. 2B, or may be twisted to create structure for the screen, as is known in the art.

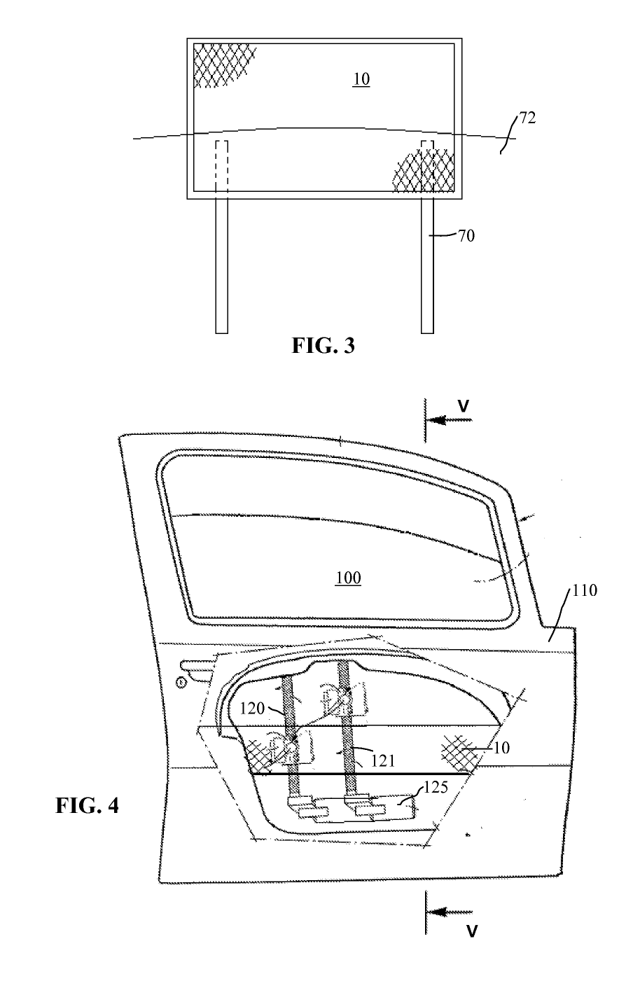

According to an embodiment of the invention, the screen 10 is designed for installation within the door of a vehicle. The vehicle is designed and built to include the screen within the door of the vehicle. FIG. 3, a partial cutaway view of a vehicle door 72, illustrates such an embodiment. The screen 10 is connected to a pair of tracks 70 which extend next to the screen 10. The tracks 70 may be adjacent the side of the screen, as illustrated in FIG. 3, or may be on the edges of the screen, as with the window glass. Preferably, the screen is installed next to the glass, on either the outside or inside of the glass. The screen 10 includes structure for raising and lowering the screen 10 in the same manner as for the window glass. Preferably, an electric motor is used to raise and lower the screen.

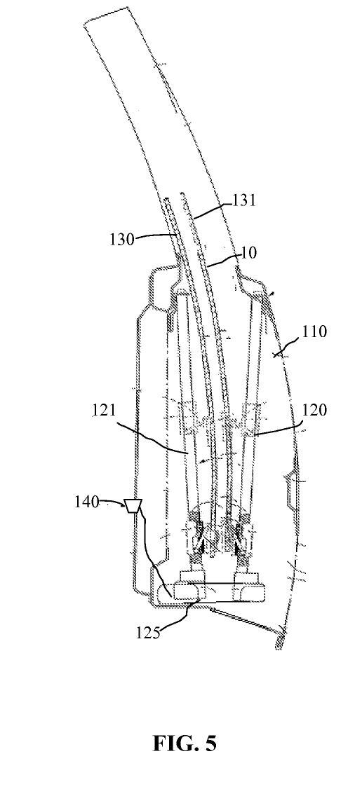

FIGS. 4 and 5 illustrate another embodiment of the invention with the screen in the door of the vehicle. In this embodiment, the screen 10 is also positioned next to the window glass 100 within the door 100. A pair of tracks 130, 131 are positioned parallel to each other along the sides of the glass 100 and screen 10. The tracks 130, 131 maintain the relative positions of the glass 100 and screen 10 and guide them through the door. Two window regulators 120, 121 are connected to the screen 10 and glass 100, respectively, to raise or lower them. As illustrated in FIG. 5, the regulators 120, 121 may be positioned on opposite sides of the screen 10 and glass 100. The regulators 120, 121 illustrated in FIGS. 4 and 5 are of a screw type. Of course, other types of regulators could be used. A single motor 125 operates both of the regulators 120, 121. Alternatively, a separate motor could be used for each regulator. Whether one motor or two motors are used, the motors are operated so that the screen 10 is only raised when the glass 100 is in the lowered position.

A switch 140 is included on the interior of the door to allow the user to raise and lower the screen 10 and glass 100. Preferably, the switch 140 is a self-centering toggle switch as is known and commonly used to operate windows on automobiles. A single switch 140 can be used for both the glass 100 and the screen 10. Alternatively, separate switches could be used for the glass 100 and screen 10. With a single switch 140, the switch 140, motor 125 and regulators 120, 121 are arranged so that when the switch is operated to lower the glass 100, after the glass reaches the lowered position, the screen 10 is raised through continued operation of the switch 140. In this embodiment, the regulators 120, 121 would have different thread directions. When the glass 100 is in the completely lowered position, the connection between the regulator 121 and the motor 125 is separated and a connection is made between the screen regulator 120 and the motor 125. The reverse occurs when the screen 10 is lowered and the glass 100 is raised. In another embodiment, the switch 140 includes a separate selector switch. When the selector switch is in a first position, the switch 140 operates the glass 100. When the selector switch is in a second position, the switch 140 operates the screen 10.

In order to prevent a child or pet from accidentally opening the screen, the switch may be positioned away from the door in which the screen is located. For example, in many vehicles, the driver has access to switches to operate all windows, as well as switches being on each door. The screen may be operated solely from the driver's switch. Alternatively, a lock-out system controlled by the driver, as is known for control of vehicle windows, can be used to prevent accidental opening of the screen.

An embodiment of the screen which utilizes a motor has been described above. Other mechanisms can be used to operate the screen. The screen 10 could be manually operated by a window-type crank or by a pull knob, strap, or groove that allows the user to pull the screen up and out of the slot in the door. Friction or a latching system may be used to keep the screen in the raised position.

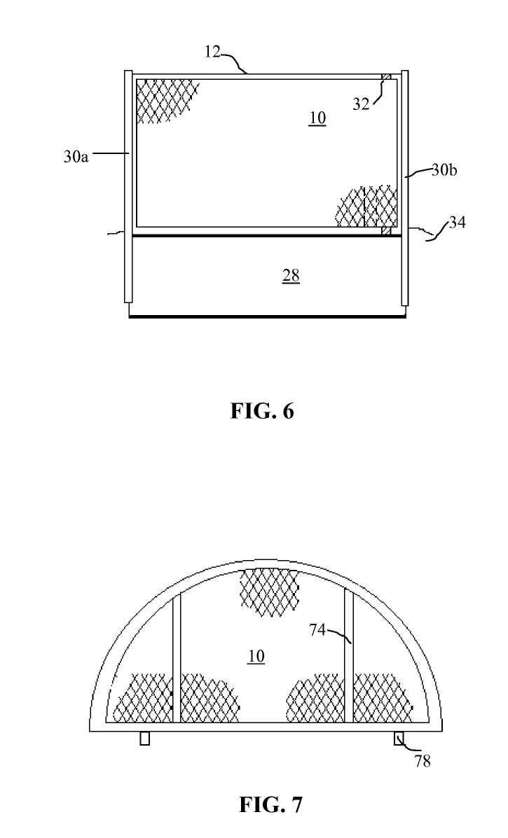

Other embodiments of the screen of the present invention may be used as aftermarket accessories. There are a number of types of vehicle windows for which the screen 10 could be adapted. In windows with a frame, the window glass moves within opposite tracks 30a, 30b attached to the vehicle door 34 as illustrated in FIG. 6. The frame 12 of the screen 10 is shaped to be thin enough to fit within the tracks with the window glass. One side of the frame is movable relative to the rest of the frame so that the screen can be made slightly smaller. The movable side is spring loaded to return the screen 10 to its normal size. The mesh 14 for that part of the screen may be of a less rigid material to allow compression. The spring-loaded side 32 is pushed in to compress the screen. The screen is then placed in the track 30a and aligned with the window glass 28. The spring-loaded side is released so that the screen 10 returns to is normal size. The spring pushes the side 32 of the frame 12 into the opposing track 32b of the window frame. After the screen is installed within the tracks 30a, 30b, the window glass 28 is raised to lock the screen in place.

Sport-utility vehicles (SUVs) sometimes have a large rear window which can move within the rear door. The screen 10, as illustrated in FIG. 7 can be installed in the same manner. However, the screen 10 may be reinforced with rods or braces 74 to provide greater rigidity to the screen. The rods 74 may be of a metal or plastic material of sufficient strength to provide the desired rigidity. Clamps 78 may be used to attach the screen 10 to the window opening.

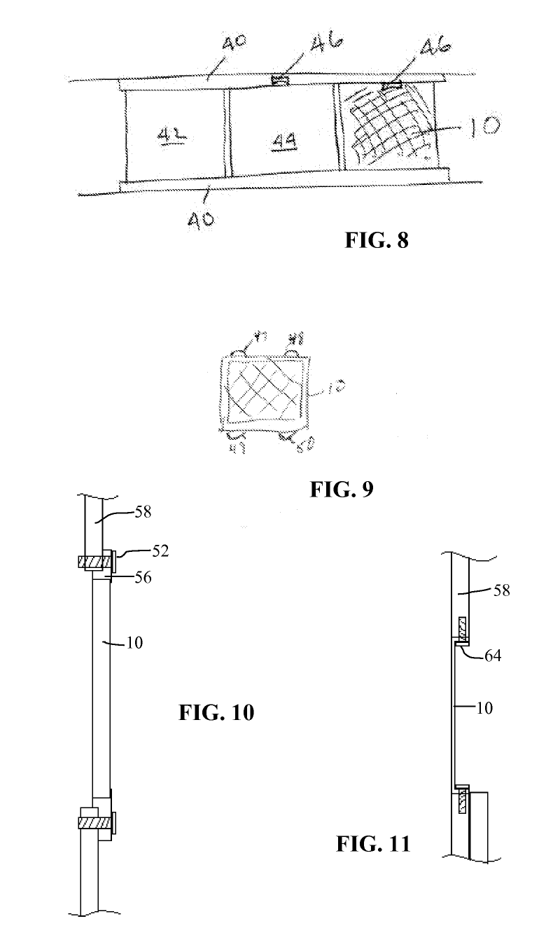

The rear window of a pickup truck typically has a window which slides sideways in a track between one or more fixed windows. As shown in FIG. 8, the track 40 can be extended to the other side of the opening 44. The sliding window 42 is installed on one side of the track 40. The screen 10 is installed on the other side of the track 40. The screen 10 slides into place over the window opening 44 when the sliding window 42 is open. Alternatively, the screen may be positioned into the track when the window is opened. FIG. 9 illustrates an embodiment of the screen 10 for insertion in an existing window track. Resilient extensions 47, 48, 49, 50 are positioned on the sides of the screen 10. The extensions 47, 48, 49, 50 may have various forms. According to one embodiment, the extensions are formed as U-shaped metal pieces. The ends can move within the frame 12 of the screen 10. To place the screen in the track 40, the extensions are compressed. The screen 10 is sized to fit between the track. The extensions expand upon release to hold the screen 10 within the track 40.

Another type of window is one that slides vertically in a track, such as a school bus window. A screen 10 for use in such a window is illustrated in FIGS. 10 and 11. The screen 10 can be installed over the window 50 using screws 52 into the frame 56 that overlaps the window frame 58. Alternatively, the screen 10 can be installed relatively permanently within the window frame 60, as shown in FIG. 11, with screws 64 or other similar attachments. Alternatively, a separate track may be attached to the outside of the school bus window. The frame of the screen 10 slides within the track to keep the screen in place.

Another type of window is a side sliding window on a transit bus. The screen 10 can fit into the window as in FIG. 4. Alternatively, it can be installed in tracks between the fixed and sliding windows and slide parallel to the windows. Alternatively, like the school bus, it can be installed on a set of additional tracks on the outside of the window.

Finally, another type of window is a fixed window, such as the rear window of a van. The screen can be clamped or bolted into place to provide security for the window.

Having disclosed at least one embodiment of the present invention, various adaptations, modifications, additions, and improvements will be readily apparent to those of ordinary skill in the art. Such adaptations, modifications, additions and improvements are considered part of the invention which is only limited by the several claims attached hereto.

1. A vehicle safety screen comprising:
a pair of adjacent tracks;
window glass positioned within one of the pair of adjacent tracks;
a screen positioned within a second one of the pair of adjacent tracks, wherein the screen includes:
a rigid mesh;
a frame surrounding the rigid mesh;
a first regulator connected to the window glass for moving the window glass within the track;
a second regulator connected to the screen for moving the screen within the track; and
at least one motor connected to the first regulator and second regulator.

2. The vehicle safety screen according to claim 1 wherein the safety screen is positioned within a door of the vehicle.
